(19) United States
(12) Patent Application Publication
(10) Pub. No.: US 2025/0128400 A1
(43) Pub. Date: Apr. 24, 2025

(54) Systems and Techniques for Implementing Autonomous Robots and Payload Management Systems

(71) Applicant: Vayu Robotics, Inc., Palo Alto, CA (US)

(72) Inventors: Anand Gopalan, Foster City, CA (US); Nitish Srivastava, Cupertino, CA (US); Mahesh Krishnamurthi, Saratoga, CA (US); Huaijin Chen, Belmont, CA (US); Rajanatha Shettigara, San Jose, CA (US); Arul Gupta, Palo Alto, CA (US); Hesam Rabeti, Palo Alto, CA (US); Vinaykumar Subrahmanya Hegde, San Jose, CA (US); Peter Jans Gillespie, Redwood City, CA (US); Arian Houshmand, Redwood City, CA (US); Sudhansh Yelishetty, Palo Alto, CA (US); Dhruv Bisla, Palo Alto, CA (US); Jason Louis Ashton, Palo Alto, CA (US)

(73) Assignee: Vayu Robotics, Inc., Palo Alto, CA (US)

(21) Appl. No.: 18/922,118

(22) Filed: Oct. 21, 2024

Related U.S. Application Data
(60) Provisional application No. 63/591,700, filed on Oct. 19, 2023.

(51) Int. Cl. B25J 5/00; B25J 9/12; B25J 13/08; B25J 15/00

(52) U.S. Cl. CPC B25J 5/007; B25J 9/123; B25J 13/087; B25J 15/0019

(57) ABSTRACT

Systems and methods for payload management systems are illustrated. One embodiment includes a delivery mechanism. A mechanical linkage in the delivery mechanism includes rocking bars mounted to: a chassis and a first cross bar The mechanical linkage includes linear actuators that include piston-type actuators configured to move at least one payload in and out of a compartment. One end of each linear actuator is mounted to an individual rocking bar. The mechanical linkage includes at least one grapple, wherein each grapple comprises a hook mounted to a claw; and is mounted to a second cross bar. The hook is configured to open and close around the at least one payload; and rotate around the claw. The delivery mechanism includes a control circuit configured to open, close, and rotate the hook using a grapple motor and/or an end-of-travel switch; and to move the linear actuators relative to the rocking bars.

### FIELD OF THE INVENTION

The present invention is generally related to autonomous vehicles and payload management. More particularly, it corresponds to sensor configurations, and transportation systems directed to delivery.

### CROSS-REFERENCE TO RELATED APPLICATIONS

The current application claims the benefit of and priority under 35 U.S.C. § 119(e) to U.S. Provisional Patent Application No. 63/591,700, entitled “Systems and Devices for Autonomous Robots and Payload Management Systems,” filed Oct. 19, 2023, the disclosure of which is hereby incorporated by reference in its entirety for all purposes.

### SUMMARY OF THE INVENTION

Systems and methods for payload management systems are illustrated. One embodiment includes a delivery mechanism. A mechanical linkage in the delivery mechanism includes a plurality of rocking bars. The rocking bars are mounted to: a chassis, at a first end of the rocking bar; and a first cross bar, at a second end of the rocking bar. The mechanical linkage includes a plurality of linear actuators. The plurality of linear actuators include piston-type actuators configured to move at least one payload in and out of at least one compartment. One end of each linear actuator of the plurality of linear actuators is mounted to an individual rocking bar of the plurality of rocking bars. The mechanical linkage includes at least one grapple, wherein each grapple of the at least one grapple comprises a hook mounted to a claw; and is mounted to a second cross bar. The hook is configured, in response to a grapple motor, to open and close around the at least one payload; and rotate around the claw. The delivery mechanism includes a control circuit. The control circuit is configured to open, close, and rotate the hook using at least one of the grapple motor or an end-of-travel switch. The control circuit is further configured to move the plurality of linear actuators relative to the plurality of rocking bars.

In a further embodiment, the delivery mechanism further includes a vehicle frame appended to the chassis. The delivery mechanism further includes a plurality of panels attached to the vehicle frame, wherein the plurality of panels construct the at least one compartment. The delivery mechanism further includes a plurality of wheels, wherein the plurality of wheels are appended to the chassis; and powered by a centralized motor to transport the delivery mechanism to a predetermined destination.

In a further embodiment, the delivery mechanism, further including a plurality of sensors, wherein the plurality of sensors is used to identify a given payload of the at least one payload, to configure the hook to open and close around the given payload; and/or to identify the predetermined destination.

In a still further embodiment, in response to the identification by the plurality of sensors, the mechanical linkage is configured to pick up the given payload from the predetermined destination; and/or drop off the given payload at the predetermined destination.

In another further embodiment, the mechanical linkage has a plurality of modes. In a travel mode, the mechanical linkage is in a retracted configuration; and the delivery mechanism is traveling to the predetermined destination. In a delivery mode, the mechanical linkage is in an extended configuration; and the delivery mechanism is stationary.

In a further embodiment, no weight is applied, from the at least one payload to the mechanical linkage, when the mechanical linkage is in the travel mode and in the delivery mode.

In another further embodiment, the plurality of sensors includes a plurality of cameras, wherein the plurality of cameras are appended on top of the vehicle frame; and/or a plurality of ultrasonic sensors, wherein the plurality of ultrasonic sensors are appended to the chassis.

In a further embodiment, the plurality of cameras overhang at least one contour connecting a first panel appended to the vehicle frame to a second panel appended to the vehicle frame. The at least one contour is configured such that each field of view cone produced by the plurality of cameras excludes the delivery mechanism.

In another further embodiment, the plurality of cameras includes: two front-facing cameras; and two rear-facing cameras, wherein the two rear-facing cameras are placed opposite the two front-facing cameras on the top of the vehicle frame.

In a still further embodiment, the plurality of cameras further includes: two front-side cameras, wherein the two front-side cameras have a 45-degree yaw inward; and two rear-side cameras. The two rear-side cameras have a 45-degree yaw inward; and are placed opposite the two front-side cameras on the top of the vehicle frame.

In another further embodiment, the hook connects to the control circuit through a close hook wireless relay in the control circuit; and/or an open hook wireless relay in the control circuit.

In a further embodiment, the close hook wireless relay is coupled to a closed travel limit switch; and the open hook wireless relay coupled to an open travel limit switch.

In another embodiment, at least one of the close hook wireless relay or the open hook wireless relay is coupled to the centralized motor.

In another further embodiment, the delivery embodiment further includes a gate, wherein at least two of the plurality of linear actuators are arranged in parallel; attached to either side of the gate; and configured to convert the gate into a ramp for the at least one payload.

In another further embodiment, the gate includes a conveyor belt.

In another embodiment, the end-of-travel switch determines when the grapple motor activates, deactivates, and changes direction.

In yet another embodiment, the delivery mechanism further includes a hanger, wherein the hanger provides additional support to weights of the at least one payload when one or more payloads of the at least one payload are moved by the mechanical linkage.

In still yet another embodiment, the at least one grapple includes a motor relay, wherein the motor relay controls the grapple motor.

In a further embodiment, the grapple motor is configured to mesh a gear to rotate the hook relative to the claw.

In another embodiment, a first grapple of the at least one grapple is configured to open to release a first payload of the at least one payload, while a second grapple of the at least one grapple remains closed around a second payload of the at least one payload.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A-1I conceptually illustrate an autonomous robot implemented in accordance with some embodiments of the invention.

FIGS. 2A-2K conceptually illustrate a payload management system configured, in accordance with certain embodiments of the invention, for managing multiple packages.

FIG. 3 conceptually illustrates a circuit capable of controlling grapples in accordance with various embodiments of the invention.

FIGS. 4A-4C conceptually illustrates a grapple configured in accordance with many embodiments of the invention.

FIGS. 5A-5C conceptually illustrate a mechanical linkage for payload management systems implemented in accordance with numerous embodiments of the invention.

FIG. 6A-6B conceptually different modes of a payload management system, implemented in accordance with several embodiments of the invention.

FIG. 7 conceptually illustrates a payload management system with extendible communication wires applied in accordance with miscellaneous embodiments of the invention.

FIGS. 8A-8B conceptually illustrate a payload management system configured to carry bags in accordance with numerous embodiments of the invention.

FIG. 9 conceptually illustrates a payload management system incorporating hangers in accordance with many embodiments of the invention.

FIGS. 10A-10D conceptually illustrate a payload management system with grapples arranged in parallel and supported by hangers in accordance with a number of embodiments of the invention.

FIG. 11 conceptually illustrates a payload management system incorporating a conveyor belt in accordance with some embodiments of the invention.

FIG. 12 conceptually illustrates an autonomous robot implemented in accordance with miscellaneous embodiments of the invention.

### DETAILED DESCRIPTION

Autonomous robots in accordance with several embodiments of the invention may be equipped with various sensors including but not limited to imaging sensors (i.e., cameras), gyroscopes, pressure sensors, and ultrasonic sensors. In various embodiments, the sensors may be used to identify when the autonomous robot has reached a (e.g., predetermined) destination and/or identify particular payloads. In many embodiments, sensors can be collectively placed on one or more sensor plane. In some embodiments, sensor planes including but not limited to camera planes may be located at various points relative to autonomous robots (e.g., at or near the top, appended to the side, etc.). In accordance with several embodiments, one sensor plane, including one type of sensor, may be located at one area, while another sensor plane, including another type of sensor, may be located at a second area. For example, a plane of ultrasonic sensors can, in accordance with several embodiments of the invention, be placed on a plane near the bottom of an autonomous robot (e.g., a chassis), while a plane of cameras is placed near the top of the autonomous robot. The various sensors can, additionally or alternatively, vary in position and/or configuration; for example, certain sensors may be positioned facing forward, backward, and/or at an angle relative to the side of the autonomous robot. While various sensor configurations and placements are discussed below with reference to a variety of different autonomous robots, autonomous robots in accordance with various embodiments of the invention can use any of a variety of combinations of sensors and/or sensor placements as appropriate to the requirements of specific applications.

In accordance with several embodiments of the invention, autonomous robots can, additionally or alternatively, incorporate payload management systems to manage transportation or cargo/payloads including but not limited to packages, bags, boxes, and/or containers. Payload management systems can be capable of transferring a selected number of payloads into and/or out of autonomous robots. This can be especially useful for delivery applications. Payload management systems can perform deliveries, in accordance with various embodiments of the invention, using mechanical linkages capable of lifting payloads of predetermined sizes and placing them on a ground surface. These payloads may be lifted in response to events including but not limited to the identification of payloads and/or destinations by sensor(s). In several embodiments, payload management systems can be capable of transitioning between two or more modes, including but not limited to modes directed to deliveries and/or travel. Travel modes may be used to allow payloads to be moved by autonomous robots between locations. Delivery modes can correspond to autonomous robots placing selected payloads on the ground to complete a delivery.

As can readily be appreciated, the specific requirements of the payload management system of a given autonomous robot are largely dependent upon the requirements of a specific application. A variety of autonomous robots including (but not limited to) autonomous delivery vehicles are discussed further below.

### Autonomous Robots

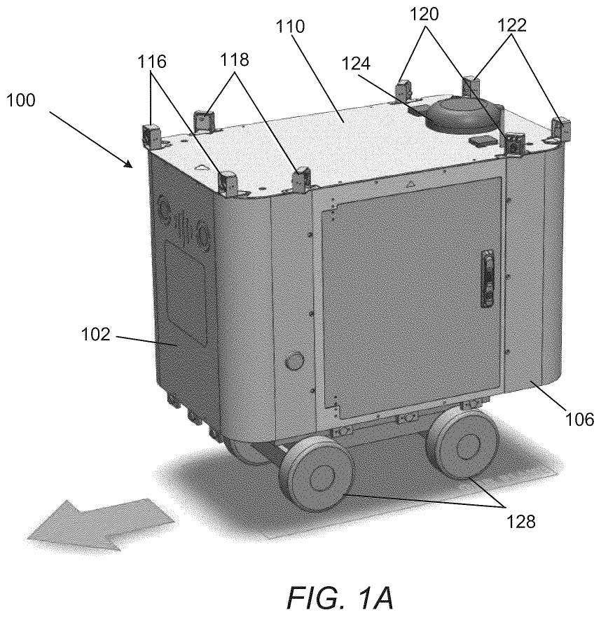

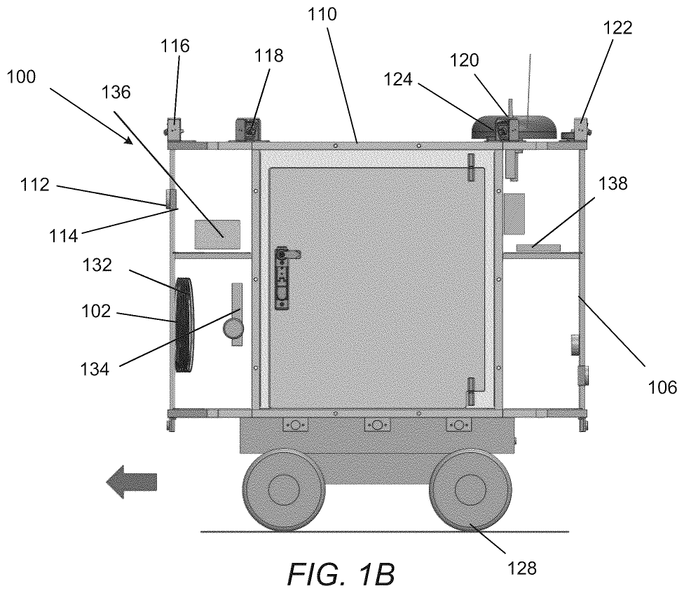

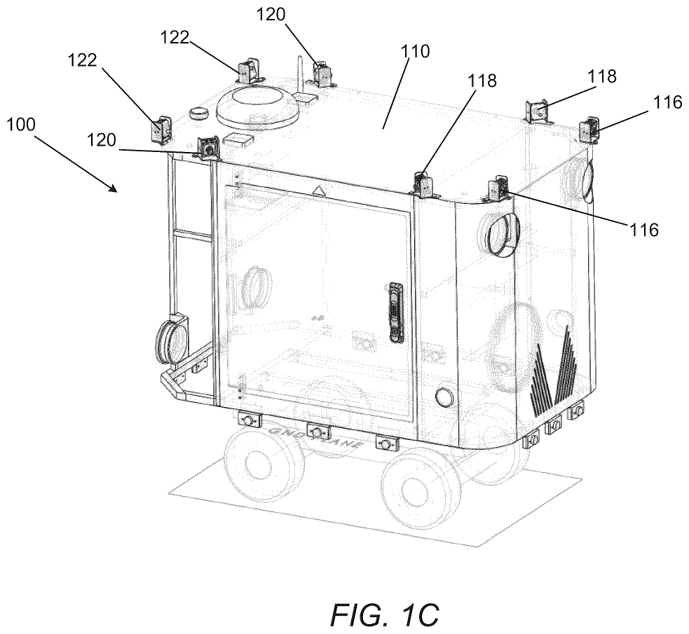

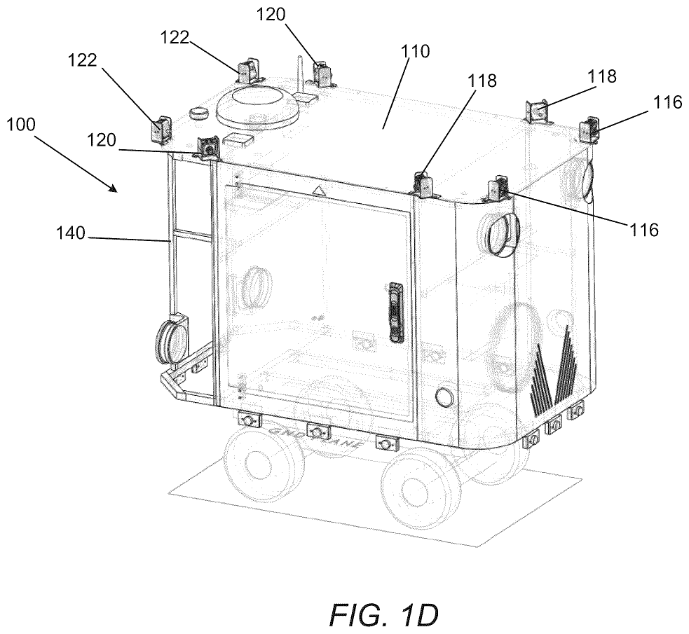

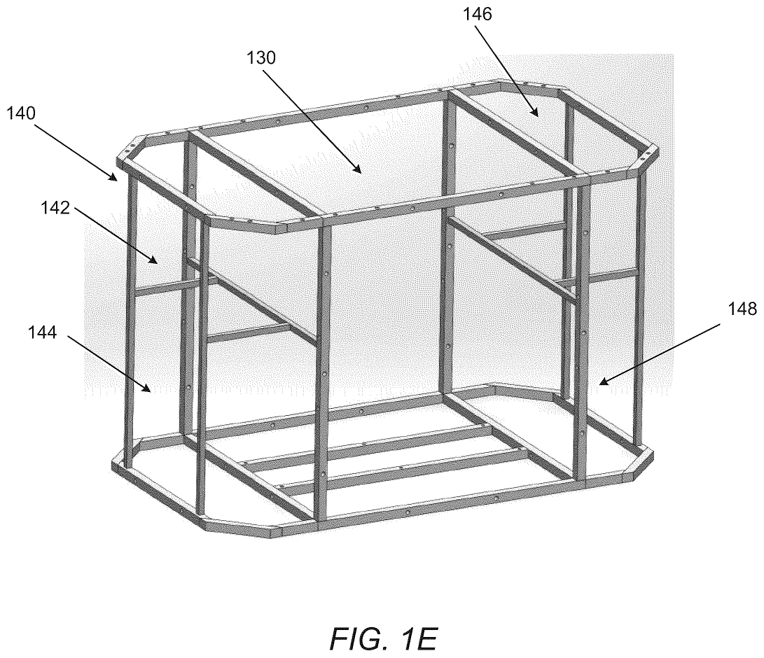

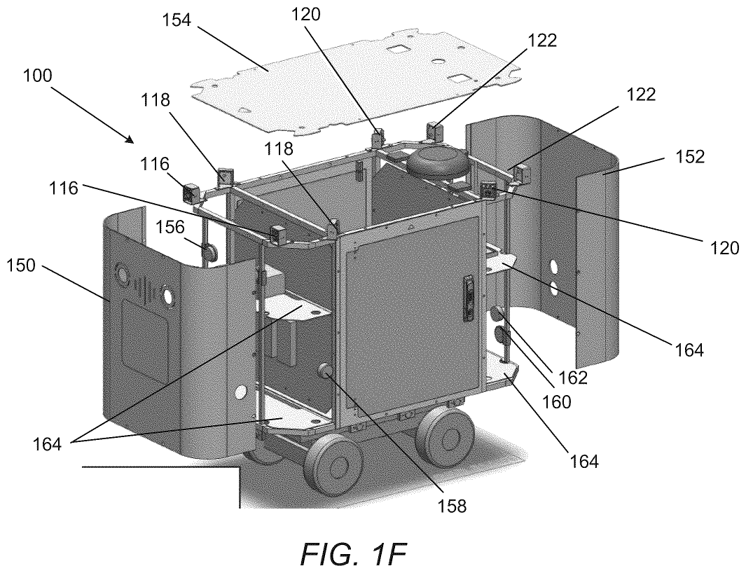

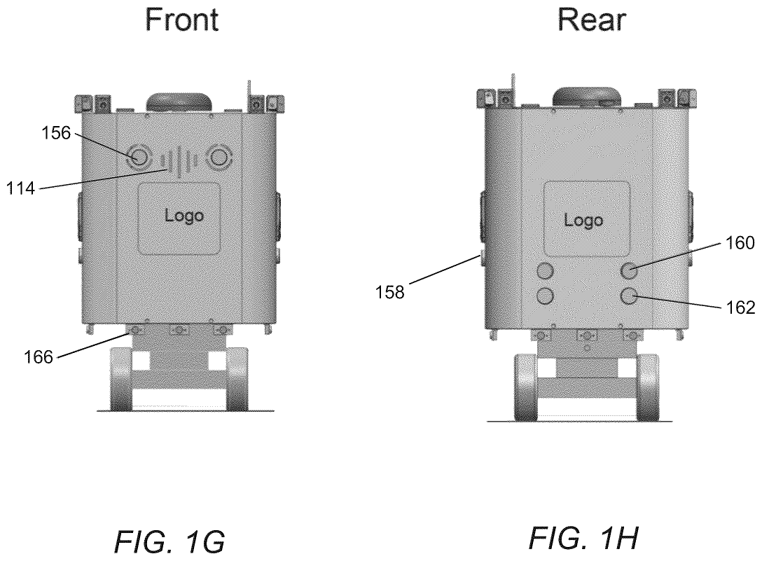

In accordance with several embodiments of the invention, autonomous robots can utilize systems and methods similar to those described in U.S. patent application Ser. No. 18/416,820, entitled “Systems and Methods for Performing Autonomous Navigation,” filed Jan. 18, 2024, the disclosure of which, including the disclosure related to the implementation of autonomous robots and autonomous vehicles, is hereby incorporated by reference herein in its entirety. An example of an autonomous robot implemented in accordance with some embodiments of the invention is conceptually illustrated in FIG. 1A through FIG. 11. The autonomous robot 100 includes a front-side 102, a rear-side 104, a first side 106, a second side 108, and a top side 110. While a specific body shape for the autonomous robot is illustrated, autonomous robots in accordance with various embodiments of the invention can have any body shape that is appropriate to the requirements of a given application.

The top side 110 of the autonomous robot 100 can include multiple cameras. For example, the implementation depicted in FIGS. 1A-1L depicts a camera plan on top of the autonomous robot. The camera plane includes eight cameras including two front-facing cameras 116, two front-side cameras 118, two rear-side cameras 120, and two rear-facing cameras 122. In accordance with many embodiments of the invention, the cameras can be rigidly mounted to the relevant (e.g., top) side(s). In several embodiments, the two rear-side cameras and two front-side cameras can each have an (approximate) 45-degree yaw inward. Additionally or alternatively, the field of view (FOV) cone of the cameras can be tangent and/or inset to the outer paneling of the autonomous robot 100 (the “outer skin”) in accordance with various embodiments of the invention. In several embodiments, all of the cameras in the camera plane (e.g., front-facing cameras 116, front-side cameras 118, rear-side cameras 120 and/or the rear-facing cameras 122) may, additionally or alternatively, a pitch of around 15 degrees down from a horizontal plane. In many embodiments, each of the cameras can overhang a contour connecting a top surface to the side, back or front surface. The overhang can be an overhang of around 0.5-1″. The overhang amount can be configured so the FOV cone (produced by the various sensors) excludes any skin/frame of the autonomous robot. (Non-limiting) examples of a suitable camera may include but are not limited to e-Con systems cameras (e.g., the STURDeCam). As can readily be appreciated, any of a variety of cameras and/or camera placements can be utilized as appropriate to the requirements of specific applications in accordance with various embodiments of the invention.

The autonomous robot 100 can further include electronic devices including but not limited to antennae 124. The antennae 124 can be placed at various points on the autonomous robot (e.g., near the rear-side 104, and on the top side 110). The antennae 124 can be generally centrally disposed with respect to the rear-facing cameras 122 and the rear-side cameras 120. As can readily be appreciated, any antennas included on an autonomous robot implemented in accordance with various embodiments of the invention can be placed in any of a number of different locations as appropriate to the requirements of specific applications.

In accordance with many embodiments of the invention, the autonomous robots 100 can include one or more doors and/or wheels on any of the surfaces; for example, FIGS. 1A-1L depict a door 126 on the first side 106 of the autonomous robot 100. As is discussed further below, autonomous robots in accordance with many embodiments of the invention incorporate payload management systems that can open doors (and/or other closure mechanisms) and deliver payloads contained within the autonomous robot during transport. Additionally or alternatively, the autonomous robot 100 can be propelled by a set of wheels 128 (e.g., FIGS. 1A-1L depicting a set of 4 wheels) located near the bottom of the autonomous robot 100 to and from destinations.

The autonomous robot 100 can have one or more internal compartments and/or support components. In accordance with many embodiments, one of the doors 126 can lead to a storage compartment that can serve functions including, but not limited to, storing payloads. Additionally or alternatively, support components located within the autonomous robot 100 can include but are not limited to communicative connectors (e.g., Fakra Cables 132), a power distribution system 134, computing components (e.g., a control system 136), and/or navigation components (e.g., a GPS transmitter, a GPS receiver 138). In several embodiments, as disclosed below the control system 136 can be a computer system based upon an Nvidia Orin. As can readily be appreciated, any of a variety of control systems can be utilized as appropriate to the requirements of a given application.

As mentioned above, the various sides of the autonomous robot 100 (including but not limited to the front-side 102, rear-side 104, first side 106, second side 108, and top side 110) can be formed by skins attached to a frame 140. The frame 140 can be seen in FIGS. 1D-1E in the context of the autonomous robot 100. As shown in FIG. 1D, the frame 140 is configured to support the various components of the autonomous robot 100. The frame 140 is shown in isolation in FIG. 1E. In the illustrated embodiment, the configuration of the frame 140 can (additionally or alternatively) serve to define multiple compartments of the autonomous robot 100 including but not limited to the storage compartment 130, a top frontal compartment 142, a bottom frontal compartment 144, a top rear compartment 146, and a bottom rear compartment 148. In several embodiments, frames of autonomous robots can be made of various materials including but not limited to steel, polycarbonate, and/or aluminum tubing. The example disclosed in FIGS. 1D-1E disclose (aluminum) tubing that is 0.75″ square, hollow, and welded tubing; nevertheless, tubing used in frames 140 configured in accordance with various embodiments of the invention may vary in shape (e.g., square, round), size (e.g., side length, radius), emptiness (e.g., hollow, solid) and/or means of manufacture (e.g., seamless, welded).

Fasteners including but not limited to threads (e.g., RivNuts) and/or screws may be used for mounting components (e.g., a skin, camera, and/or other components) to the tubing. In some embodiments, the tubing can be disposed on the tubing. As can readily be appreciated, the specific shape, number of compartments, and manner of construction of the frame and exterior walls of an autonomous are largely dependent upon the requirements of a given application.

The autonomous robot 100 in a partially exploded view is conceptually illustrated in FIG. 1F. Frames 140 implemented in accordance with several embodiments of the invention can be used to mount skins, panels, cameras, and other equipment to autonomous robots. In the illustrated embodiment, the frame 140 is shown as supporting multiple cameras 116, 118, 120, and 122. As described above, the positioning and/or number of sensors implemented in accordance with various embodiments of the invention can vary. For example, in some cases it can be beneficial to mount cameras directly to the frame of an autonomous robot such that they are rigidly and accurately attached.

Views of the panels of the autonomous robot 100 are conceptually illustrated in FIGS. 1G-1H (as well as FIG. 1F). Panels including but not limited to a front panel 150, back panel 152, and top panel 154 can each be mounted to the frame 140. In many embodiments of the invention, panels can house various illumination (e.g., lights 156, 158) and/or ventilation (e.g., ventilation grill 114) components. For example, the front panel 150 can include apertures for front lights 156, and side signal lights 158, e.g., where the front lights 156 and side signal lights 158 are mounted to the frame 140. The (side) signal lights 158 can be disposed on the first side 106 and second side 108. Additionally or alternatively, the back panel 152 can include apertures for rear signal lights 160 and rear brake lights 162 that can be mounted to the frame 140. The rear signal lights 160 and the rear brake lights 162, in some cases can be disposed on the rear-side 104. Additionally or alternatively, other panels 164 may be used for purposes including but not limited to bounding the above compartments. For example, FIG. 1F shows that each of a top frontal compartment 142, bottom frontal compartment 144, top rear compartment 146, and a bottom rear compartment 148 is bounded (on the bottom) by panels 164. In many embodiments, all or some of the panels 164 can be mounted to the frame 140 and can be suitable for supporting one or more components.

Additionally or alternatively, in accordance with many embodiments of the invention, sensors 166 can be disposed along various surfaces of the autonomous robot 100, including but not limited to the frame 140. For example, FIGS. 1G-1H displays ultrasonic sensors 166 disposed along a bottom surface of the autonomous robot 100. The sensors 166 used can also vary in number and placement. In some embodiments, there can be a set of sensors 166 disposed on each of the front-side 102, first side 106, second side 108, and rear-side 104. For each side, the sensors 166 can be mounted to the frame 140. The example shown in FIGS. 1G-1H discloses a set of three ultrasonic sensors lining both the front and rear. In certain embodiments, the sensors can be positioned such that they lie on a plane below the bottom edges of the front panel 150, and/or the back panel 152. As can readily be appreciated, the specific number, placement and/or mounting of sensors such as (but not limited to) ultrasonic sensors and/or cameras is largely dependent upon the requirements of a given application.

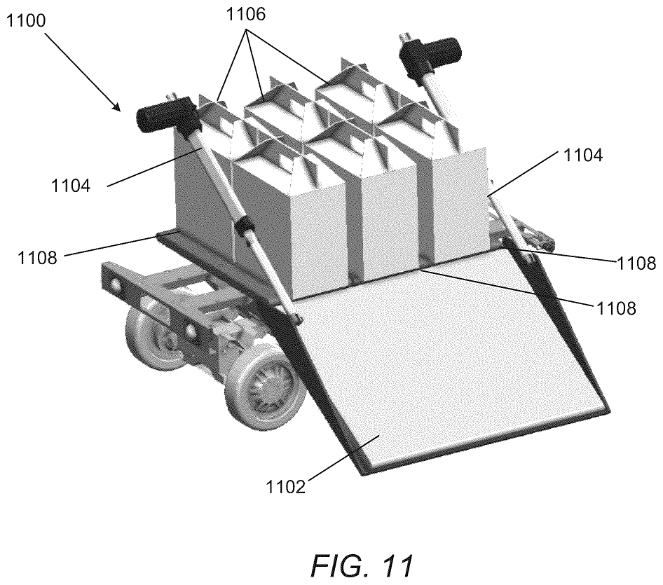

A schematic top view showing an additional configuration of sensors (e.g., cameras) is illustrated in FIG. 11. In accordance with some embodiments, the front-facing cameras 116 can be positioned a first distance (e.g., around 243.94 mm) from a Y-axis 168, and/or a second distance (e.g., around 485.59 mm) from an X-axis 170. Additionally or alternatively, the rear-facing cameras 122 can be positioned opposite to the front-facing cameras 116 and/or can be symmetric with respect to the front-facing cameras 116 where the line of symmetry is the X-axis 170 (and/or the Y-axis 168). In many embodiments, the front-side cameras 118 can be positioned a third distance (e.g., around 314.25 mm) from a Y-axis 168, and/or a fourth distance (e.g., around 316.26 mm) from an X-axis 170. Additionally or alternatively, the rear-side cameras 120 can be positioned opposite to the front-facing cameras 116 and/or can be symmetric with respect to the front-side cameras 118 where the line of symmetry is the X-axis 170. As mentioned above, in accordance with several embodiments of the invention, one or more of the cameras can all lie on a camera plane. The camera plane can vary in location and/or configuration (e.g., be disposed parallel to the top side 110, be parallel to a ground plane). In several embodiments, the distance between the camera plane and a ground plane can be around 37 and ⅞ inches. As can readily be appreciated, the number of cameras placed in the camera plane and the relationship of the camera plane to the ground plane is largely determined based upon the requirements of a given application.

In several embodiments, the frame and panels combined can weigh less than around 30 lbs. The onboard electronics (e.g., the control system), lights, cameras, antenna, and/or ultrasonic sensors can weigh less than around 10 lbs. An autonomous robot can be configured to support a payload cargo of around 20 lbs. A motor (e.g., a Segway Max) for the autonomous robot movement system can, in several embodiments, support a capacity of around 61 lbs. In several embodiments, wires for various systems (e.g., cameras, brake/tail lights, antenna) can be routed within the (i.e., hollow) tubing.

While various autonomous robots are described above with reference to FIG. 1A through 1I, the specific configuration of autonomous robots in accordance with various embodiments of the invention is largely dependent upon the requirements of a given application. In many embodiments, the autonomous robot is designed to carry multiple payloads for delivery by the autonomous robot. Payload management systems that can be utilized in autonomous robots and the construction of autonomous robots that incorporate payload management systems in accordance with various embodiments of the invention are discussed further below.

### Payload Management Systems

In many embodiments, autonomous robots (including but not limited to the autonomous robots described above with reference to FIG. 1A through 1I) can include a payload management system. Payload management systems can be positioned within one or more compartments of autonomous robots and can be configured to manage one or more boxes, bags, and/or other payloads. Various payload management systems are described herein.

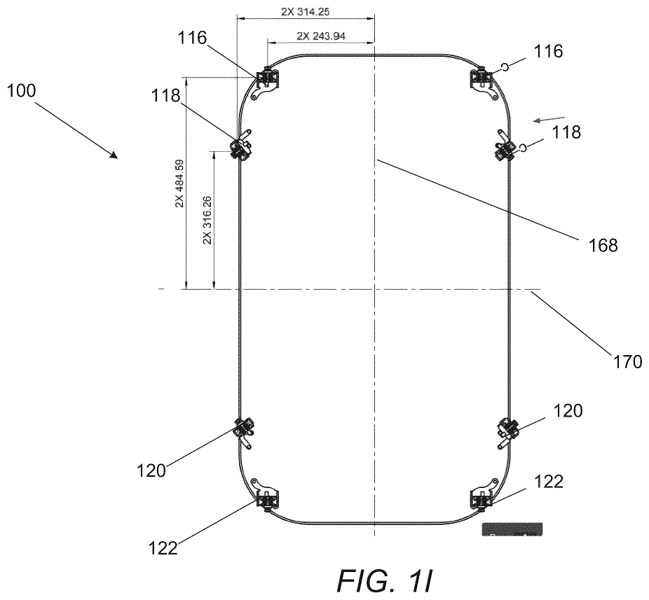

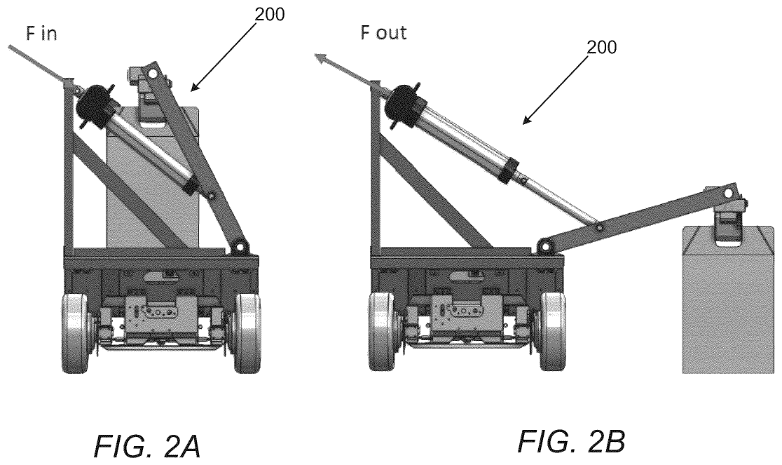

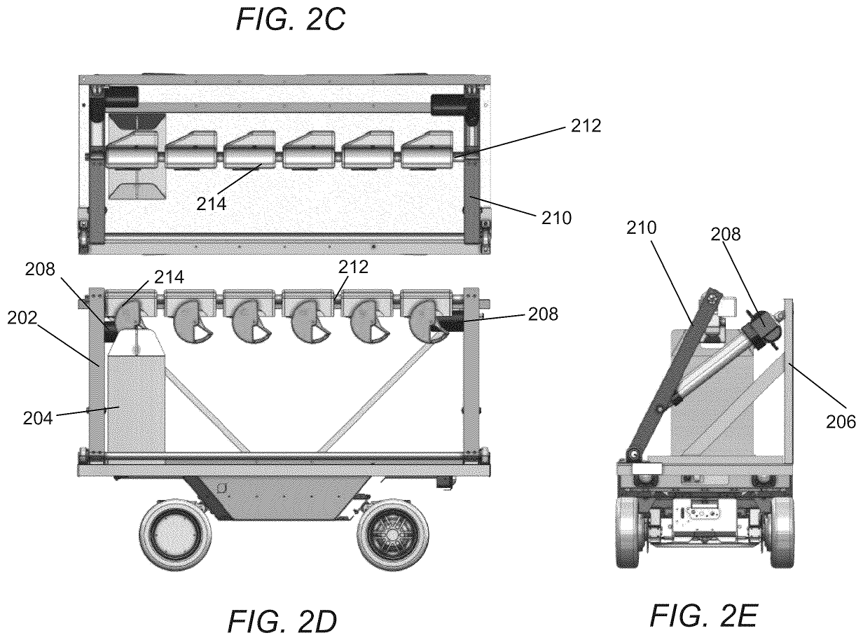

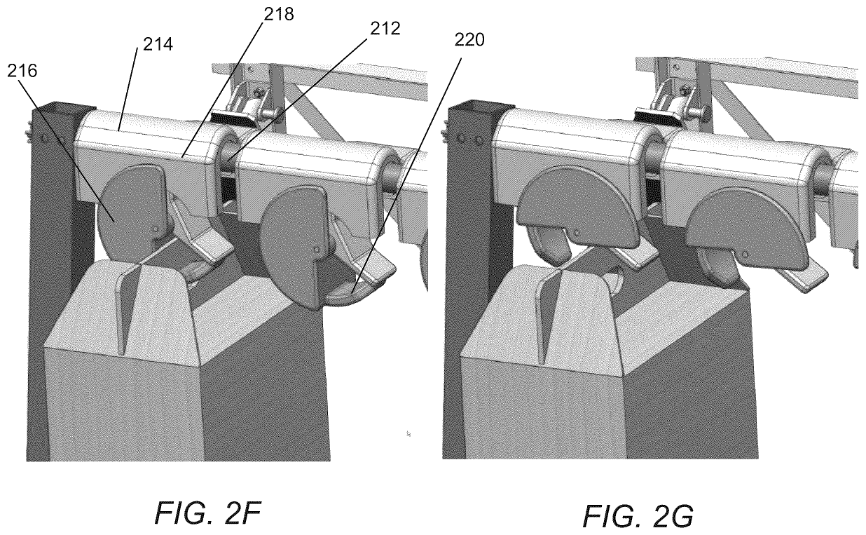

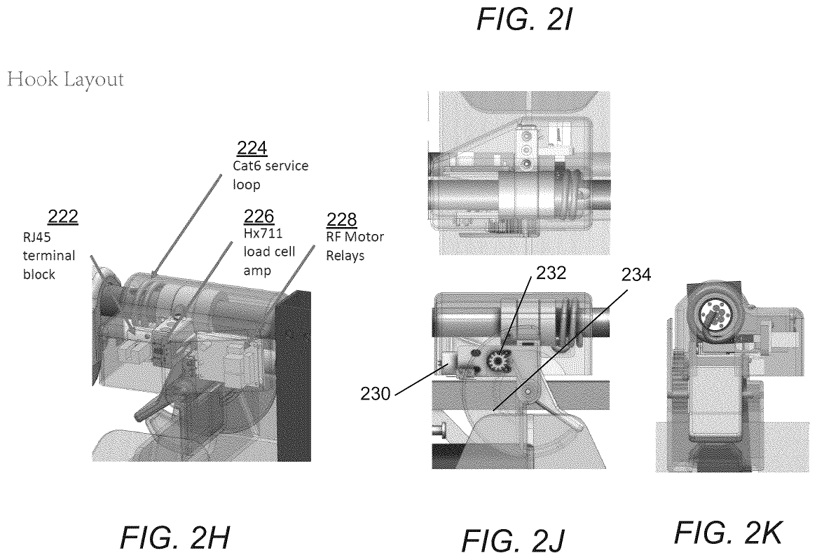

A payload management system configured for managing multiple payloads in accordance with some embodiments of the invention is conceptually illustrated in FIG. 2A through FIG. 2K. Payload management systems 202 implemented in accordance with various embodiments of the invention may utilize (but are not limited to) linear actuator(s) 208, rocking bar(s) 210, a frame 206, and grapples 214 to form a mechanical linkage capable of moving (i.e., picking up and dropping off) payloads of a pre-selected size (e.g., box 204).

In several embodiments of the invention, the payload management system is capable of transitioning between a variety of modes including but not limited to a delivery mode and a travel mode. Travel mode can be used by the payload management systems for moving payloads to a delivery location (and/or moving to a pickup location). In such cases, the payload management system may be in motion. Delivery mode can correspond to an autonomous robot placing selected payloads on the ground to complete a delivery (and/or picking up selected payloads to begin a delivery). In such cases, the payload management system may be stationary. With the desired payloads held/grappled, mechanical linkages can transition a payload management system from a travel mode (e.g., with the mechanical linkage in a retracted configuration) to delivery mode (e.g., with the mechanical linkage in an extended configuration).

In accordance with many embodiments of the invention, the mechanical linkage used by payload management systems 202 implemented in accordance with several embodiments of the invention may utilize a variety of (i.e., resting) positions when transferring payloads. In some cases (e.g., in the period after transitioning to travel mode and/or before transitioning to delivery mode), the mechanical linkage of payload management systems 202 implemented in accordance with certain embodiments of the invention can assume a first (retracted) position (shown in FIG. 2A), where the box 204 is in a first resting position within the compartment. Additionally or alternatively (e.g., immediately after transitioning to delivery mode, immediately before transitioning to travel mode) the mechanical linkage can also assume a second (extended) position (shown in FIG. 2B) where the box 204 is in a second resting position on the ground. In certain embodiments, both resting positions may be configured such that no weight of the payloads is applied to the mechanical linkage.

The mechanical linkages implemented in several embodiments of the invention, can include one or more linear actuators 208 can be mounted to a top portion of the frame 206. In several embodiments, the number of actuators can vary according to the weight requirements and/or geometry of autonomous robots to which the payload management system is connected. In several embodiments, the linear actuator(s) 208 may be implemented using piston-type actuators. As can readily be appreciated, any of a variety of different types of actuators can be utilized as appropriate to the requirements of a given application. Each of the linear actuators 208 can be mounted at a first end to the frame 206, such that the linear actuators are positioned opposite each other. Additionally or alternatively, a second end of each linear actuator 208 can be mounted to a rocking bar 210. In a number of embodiments, there may be two rocking bars 210 and/or two linear actuators. As such, there can be one rocking bar per linear actuator. The rocking bar 210 can be connected at a proximal end to a bottom portion of the frame 206 (e.g., a chassis), and a distal end to a cross bar 212. The rocking bar 210 can be coupled to the second end of the linear actuator 208 at a location between the proximal end and the distal end of the rocking bar 210. In many embodiments, movement/maneuvering of the linear actuators 208 (e.g., relative to the rocking bar) can be facilitated by control circuits.

FIGS. 2C through 2E provide plan views of the payload management system. In accordance with various embodiments of the invention, payload management systems 202 can be mounted to frames 206 through components including but not limited to chassis. Frames 206 of the payload management systems 202 can provide structural support and/or rigidness to the payload management systems 202. In various embodiments, the frames 206 can include but are not limited to a bottom portion, side portion and angled portion.

In accordance with various embodiments of the invention, grapples 214, supported by cross bars 212, may be used for manipulating payloads. The grapples 214 can be configured to engage with handles, such as (but not limited to) the handles of (i.e., payload) boxes 204. In FIGS. 2C-2E, six grapples 214 are shown; however, it is understood that any number of grapples could be used in accordance with various embodiments of the invention. Furthermore, various different types of grapples can be utilized as appropriate to the requirements of specific applications, as is discussed in further detail below.

FIG. 2F and FIG. 2G depict grapples 214 in a coupled configuration (FIG. 2F) and an uncoupled configuration (FIG. 2G). Grapples 214 implemented in many embodiments of the invention can utilize a hook 216 mounted to a claw 218 (e.g., that can be mounted to the cross bar 212) to grasp and release payloads. In this way, the grapples 214 can be positioned based on movements of the linear actuator(s) 208. The claw(s) 218 can include extensions 220 that can close the hook 216 when grapples 214 are in a coupled position. Additionally or alternatively, the hook(s) 216 can be configured to rotate relative to the claws 218. For example, the hook 216 is in a coupled position in FIG. 2F, and can be rotated from the coupled position to an uncoupled position as shown in FIG. 2G.

An example system for coupling and decoupling grapples from payloads is conceptually illustrated in FIG. 2H through FIG. 2K. In accordance with embodiments of the invention, grapples (e.g., grapple 214) can include various electronic components in the claw 218 portion that can perform functions including but not limited to driving the motion of the hook(s) 216. Grapples 214 can, additionally or alternatively, include components such as (but not limited to) terminal block(s) 222 (e.g., a RJ45 terminal block), wire service loop(s) 224 (e.g., a Cat6 service loop), load cell amplifier(s) 226 (e.g., a Hx711 load cell amplifier), motor(s) (e.g., a DC motor), motor relay(s) 228 (e.g., an RF motor relay), and/or various connectors.

In many embodiments, the motor relay 228 can control a grapple motor 230 used to drive a pinion 232 that can mesh with a gear 234 to rotate the hook 216 relative to the claw 218. Further, various embodiments of the invention can use wired connections to control the motor(s). For examples wires can be configured to stretch (e.g., uncoil) when the mechanical linkage is in the second (e.g., the second configuration shown in FIG. 2B) configuration and contract when mechanical linkage is in the first configuration (e.g., the first configuration shown in FIG. 2A). Further, in various embodiments, control circuits (can be used to open and close grapples on payload management systems.

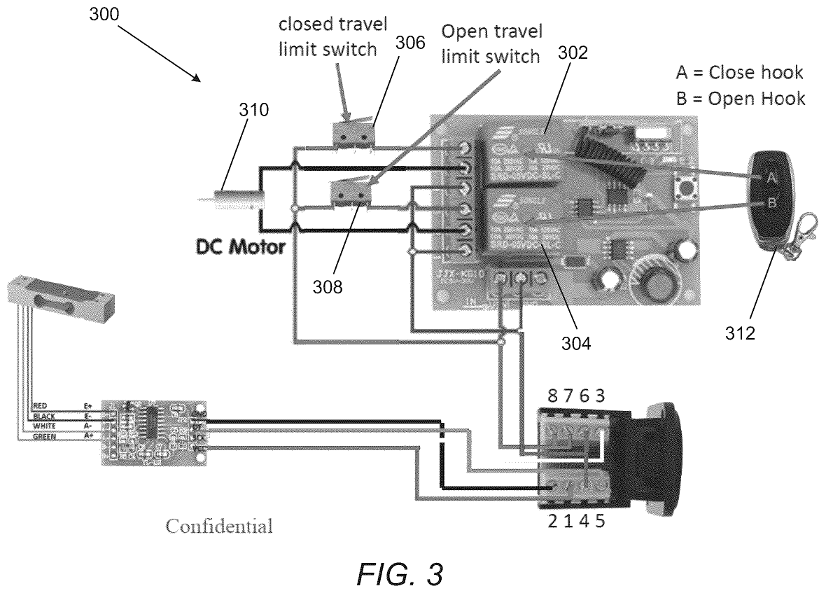

An example circuit for controlling grapples in accordance with multiple embodiments of the invention is conceptually illustrated in FIG. 3. Grapple control circuits 300 can be configured to include a close hook wireless relay 302 (that may be coupled to a closed travel limit switch 306) and an open hook wireless relay 304 (that may be coupled to an open travel limit switch 308). In accordance with many embodiments of the invention the (e.g., DC) motor 310 can be coupled to the close hook wireless relay 302 and/or the open hook wireless relay 304. Additionally or alternatively, grapple control circuits 300 can be controlled by control switches 312 and/or end-of-travel switches. End-of-travel switches can be used to control when a grapple motor should activate, deactivate, and/or change direction. As can readily be appreciated, any of a variety of control electronics can be utilized within a grapple or other coupling mechanism used within an autonomous robot as appropriate to the requirements of specific applications in accordance with various embodiments of the invention.

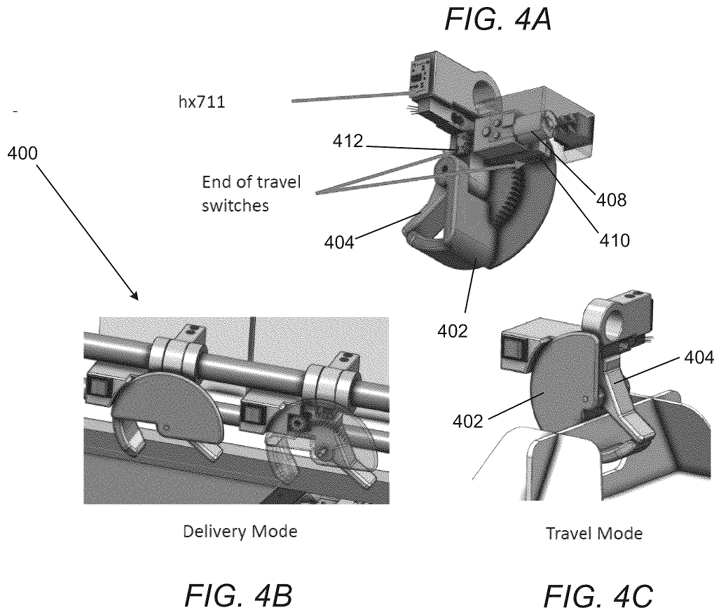

A grapple configured in accordance with many embodiments of the invention is conceptually illustrated in FIG. 4A through 4C. As mentioned above, grapples 400 can include (but are not limited to) a hook 402 and a claw 404. The hook 402 can have a gear 406 that meshes with a pinion. The pinion can be actuated by a grapple motor 408 mounted to the claw 404. The grapple motor can be controlled by at least the end-of-travel switches 410 and 412. In accordance with many embodiments, grapples can be toggled between a first (uncoupled) configuration (e.g., as seen in FIG. 4B) and a second (coupled) mode (e.g., as seen in FIG. 4C) based factors including but not limited to the rotation of the hook. In turn, hooks can be actuated based on control of motors, and/or control of motors can be based at least partially on signals from end-of-travel switches.

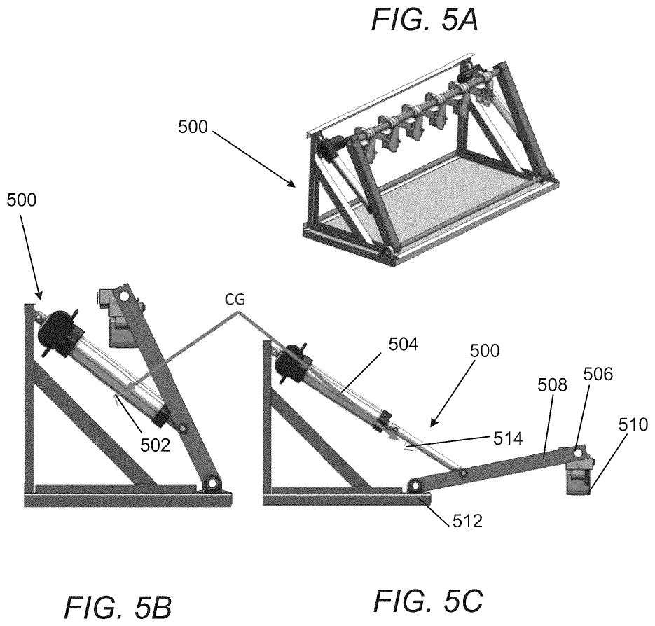

A mechanical linkage for a payload management system is conceptually illustrated in FIG. 5A through FIG. 5C. In accordance with many embodiments, a center of gravity of the moving portions of a mechanical linkage can have a center of gravity at various points including but not limited to an area within the wheel base of the autonomous robot to which the payload management system is mounted. As can be seen in FIG. 5B, when the mechanism 500 is in a retracted position, the center of gravity 502 of the linear actuator 504, cross bar 506, rocking bar 508, and/or grapples 510 can be within the width of a frame 512 (e.g., and therefore within the wheel base of an autonomous robot to which the mechanism 500 is mounted). As can be seen in FIG. 50, when the mechanism 500 is in an extended position, the center of gravity 514 of the linear actuator 504, cross bar 506, rocking bar 508, and grapples 510 can still be within the width of the frame 512 (e.g., and therefore within the wheel base of an autonomous robot to which the mechanism 500 is mounted). This can beneficially make a payload management system and an associated autonomous robot more stable.

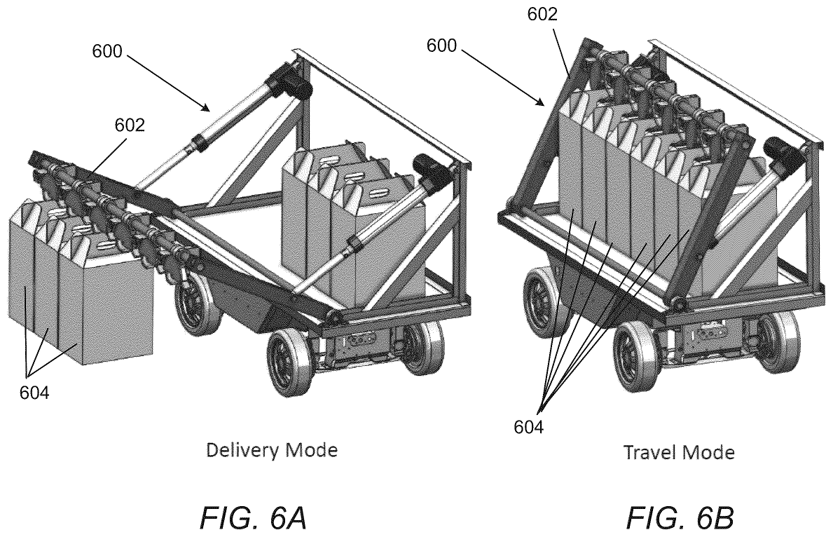

A conceptual illustration of a payload management system implemented in accordance with several embodiments of the invention in a delivery mode and a travel mode is illustrated in FIGS. 6A and 6B, respectively. As mentioned above, the payload management system is capable of transitioning between travel modes (where the payload management systems can be suitable for moving payloads by an autonomous robot to a delivery location) and delivery modes (where selected payloads are placed at predetermined spots to complete a delivery). Mechanical linkages 602 can couple to a desired number of payloads 604 through individual control of one or more grapples. With the desired payloads 604 grappled, a mechanical linkage 602 can transition a payload management system from a travel mode (e.g., with the mechanical linkage 602 in the retracted configuration) to delivery mode (e.g., with the mechanical linkage 602 in the extended configuration). Once the mechanical linkage 602 is fully extended, the grapples can release the payload 604 to complete a delivery (e.g., ground placement) of said payload. Several embodiments can be capable of coupling and uncoupling grapples to/from subsets of payloads such that only a portion of the payloads are delivered. In the delivery mode depicted in FIG. 6A, the mechanical linkage 602 is in an extended configuration and a portion of the payload 604 containers have been transferred to the ground. In the travel mode depicted in FIG. 6B, the mechanical linkage 602 is shown in a retracted configuration and all the payloads 604 remain within the payload management system.

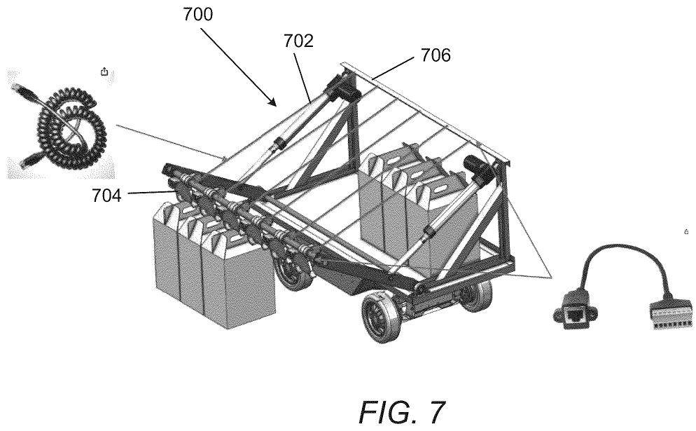

A payload management system incorporating extendible communication wires in accordance with multiple embodiments of the invention is conceptually illustrated in FIG. 7. The payload management system 700 shown in the figure is in a delivery configuration. These modes may be facilitated, in some embodiments, using wires including but not limited to communication wires (e.g., Cat6 wires). The wires 702 can connect between receivers on the grapples 704 and receivers mounted to the frame 706. The illustrated payload management system 700 is similar to many of the payload management systems described above. In the delivery configuration, the (e.g., communication) wires 702 may be stretched. Additionally or alternatively, the wires 702 can be coiled when the payload management system 700 is in travel mode.

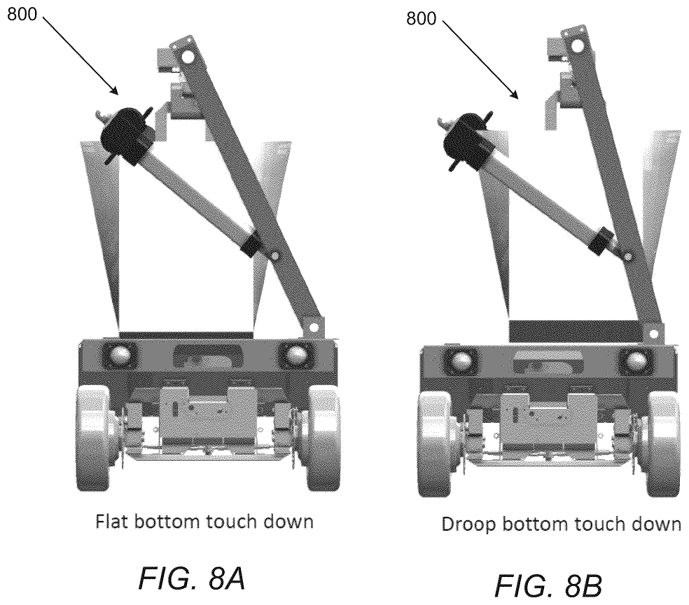

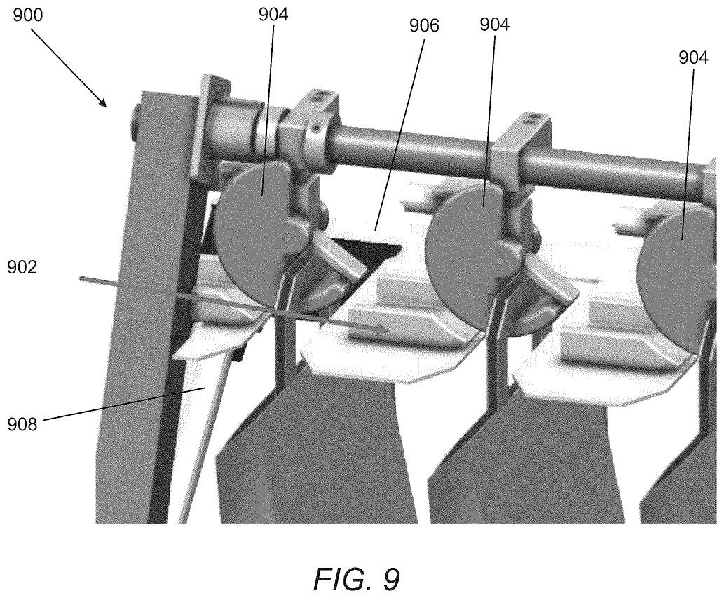

A payload management system implemented in accordance with several embodiments of the invention is conceptually illustrated in FIG. 8A and FIG. 8B. In miscellaneous embodiments of the invention, payload management systems 800 may be configured to carry payloads including but not limited to bags, boxes, and/or containers. The embodiments depicted in FIGS. 8A-8B are configured to be used for payloads that are bags. A payload management system 800 can be configured to touch down bags such that the bag bottoms are flat (as shown in FIG. 8A) and/or can be configured to touch down bags such that a drooping bag bottom touches down (as shown in FIG. 8B). As can readily be appreciated, payload management systems in accordance with embodiments of the invention can be configured for handling various payload types.

In some embodiments, hangers can be used to support payload weights in circumstances including but not limited to: when grapples are insufficient to handle the weight. Hangers can be capable of translating such that payloads suspended in grapples can be transferred from the grapples to the hangers.

A payload management system incorporating hangers in accordance with many embodiments of the invention is conceptually illustrated in FIG. 9. The payload management system 900 includes a hanger 902 positioned adjacent and/or between grapples 904. In some embodiments, hangers 902 can be supported by plate(s) 906 attached to the frame 908 of the payload management system 900. In several embodiments, the hangers 902 can be configured to support a payload transferred from one or more of the grapples. For example, in some embodiments, hangers 902 can be used in circumstances including but not limited to when the payload management system is configured in a travel mode to take weight off the grapples and/or to retain a first set of one or more payloads when the mechanical linkage extends to deliver a second set of one or more payloads.

Various mechanical linkages, hangers, and/or grapples can be used within a payload management system in accordance with various embodiments of the invention. In some embodiments, grapples can be positioned in series, such that a single hanger can be used to hold payloads associated with two or more grapples.

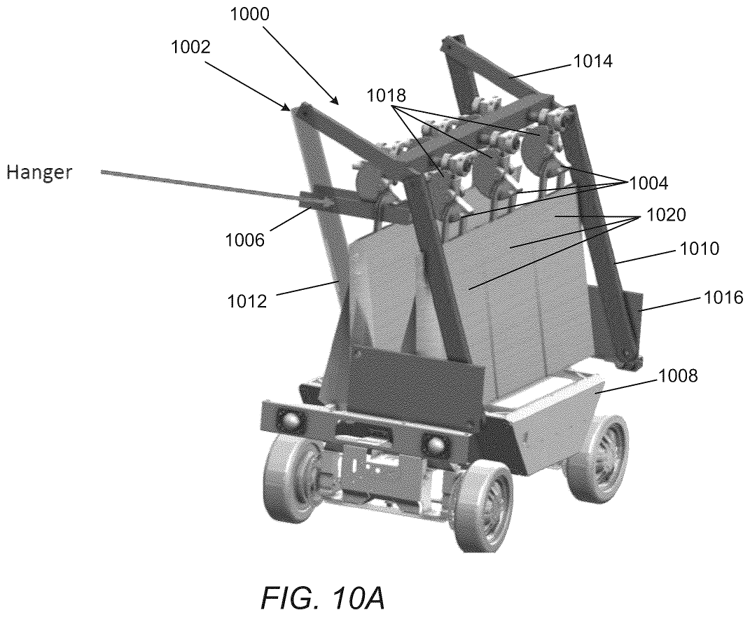

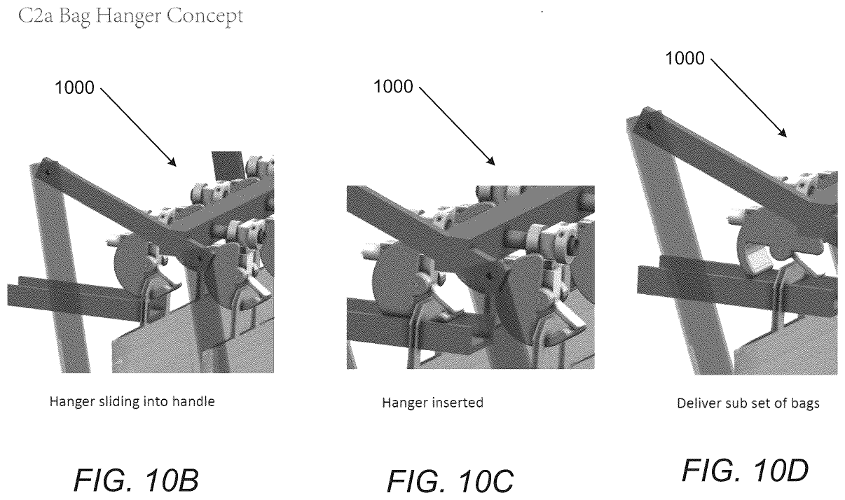

A payload management system with grapples arranged in parallel and supported by hangers is conceptually illustrated in FIG. 10A through FIG. 10D. The payload management system 1000 may include but is not limited to one or more mechanical linkage 1002 (that can be coupled to one or more grapples 1004) and/or one or more hangers 1006. The hanger(s) 1006 can be capable of translating relative to a chassis 1008 as shown in FIG. 10B through FIG. 10D. In this way, one or more hangers 1006 can receive a set of payloads from the grapples prior to the mechanical linkage(s) 1002 delivering the payloads out of the payload management system. Simultaneously to the hanger 1006 translating to support the payloads, the grapples 1004 can decouple from the payloads. The hanger(s) 1006 can be especially advantageous for preserving the location of the payload attachment points (e.g., handles) relative to the payload management system. In some embodiments, mechanical linkage(s) 1002 can include (but are not limited to) a first and second rocking bar 1010, 1012; and/or a cross bar 1014. The rocking bars 1010 and 1012 can be connected at distal ends to a cross bar 1014 and/or at distal ends to a frame 1016. Additionally or alternatively, as mentioned above, the cross bar 1014 can have grapples 1004 mounted to it; the grapples 1004 can have a motor actuated hook 1018 capable of coupling and decoupling from payloads 1020 (e.g., bags and/or boxes); and/or the mechanical linkage 1002 can be capable of moving the payloads between a travel mode and a delivery mode.

In many embodiments, payload management systems can use conveyors to advance payloads for delivery. An example payload management system with a conveyor is conceptually illustrated in FIG. 11. A payload management system 1100 can include a gate 1102 that can open (and/or be converted) into a ramp using one or more linear actuators 1104. Payloads 1106 can be advanced up to and down the ramp using one or more conveyor belts 1108. In many embodiments, separate conveyor belt(s) (e.g., the conveyor belts) can be included for each anticipated payload lane, such that payloads can be selectively unloaded.

In addition or alternative to the above features, in accordance with many embodiments of the invention, a number of components may be incorporated in accordance with various embodiments of the invention.

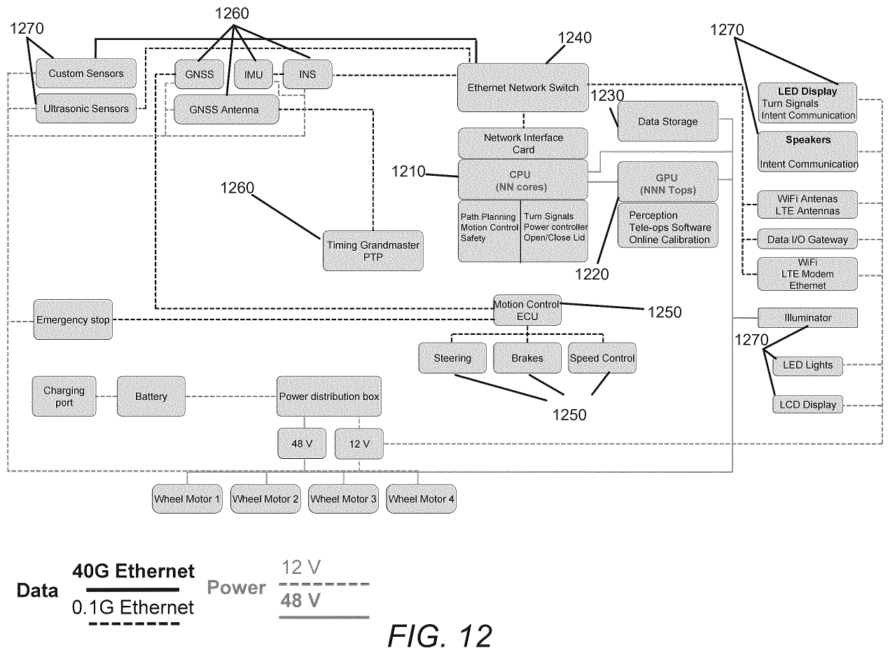

A conceptual diagram of an autonomous robot implementing systems operating in accordance with some embodiments of the invention is illustrated in FIG. 12. Autonomous robot implementations may include but are not limited to one or more processors, such as a central processing unit (CPU) 1210 and/or a graphics processing unit (GPU) 1220; a data storage 1230 component; one or more network hubs/connecting components (e.g., an ethernet network switch 1240), engine control units (ECUs) 1250, various navigation devices 1260 and peripherals 1270, intent communication 1280 components, and a power distribution system 1290.

Hardware-based processors may be implemented within autonomous robots and other devices operating in accordance with various embodiments of the invention to execute program instructions and/or software, causing computers to perform various methods and/or tasks, including the techniques described herein. Several functions including but not limited to data processing, data collection, machine learning operations, and simulation generation can be implemented on singular processors, on multiple cores of singular computers, and/or distributed across multiple processors.

Processors may take various forms including but not limited to CPUs 1210, digital signal processors (DSP), core processors within Application Specific Integrated Circuits (ASIC), and/or GPUs 1220 for the manipulation of computer graphics and image processing. CPUs 1210 may be directed to autonomous navigation operations including (but not limited to) path planning, motion control safety, operation of turn signals, the performance of various intent communication techniques, power maintenance, and/or ongoing control of various hardware components. CPUs 1210 may be coupled to at least one network interface hardware component including but not limited to network interface cards (NICs). Additionally or alternatively, network interfaces may take the form of one or more wireless interfaces and/or one or more wired interfaces. Network interfaces may be used to communicate with other devices and/or components as will be described further below. As indicated above, CPUs 1210 may, additionally or alternatively, be coupled with one or more GPUs. GPUs may be directed towards, but are not limited to ongoing perception and sensory efforts, calibration, and remote operation (also referred to as “teleoperation” or “tele-ops”).

Processors implemented in accordance with numerous embodiments of the invention may be configured to process input data according to instructions stored in data storage 1230 components. Data storage 1230 components may include but are not limited to hard disk drives, nonvolatile memory, and/or other non-transient storage devices. Data storage 1230 components, including but not limited to memory, can be loaded with software code that is executable by processors to achieve certain functions. Memory may exist in the form of tangible, non-transitory, computer-readable mediums configured to store instructions that are executable by the processor. Data storage 1230 components may be further configured to store supplementary information including but not limited to sensory and/or navigation data.

Systems configured in accordance with a number of embodiments may include various additional input-output (I/O) elements, including but not limited to parallel and/or serial ports, USB, Ethernet, and other ports and/or communication interfaces capable of connecting systems to external devices and components. The system illustrated in FIG. 12 includes an ethernet network switch used to connect multiple external devices on system networks, as is elaborated below. Ethernet network switches configured in accordance with several embodiments of the invention may connect devices including but not limited to, computing devices, Wi-Fi access points, Wi-Fi and Long-Term Evolution (LTE) antennae, and servers in Ethernet local area networks (LANs) to maintain ongoing communication. The system illustrated in FIG. 12 utilizes 40 Gigabit and 0.1 Gigabit Ethernet configurations, but systems arranged in accordance with numerous embodiments of the invention may implement any number of communication standards.

Systems configured in accordance with many embodiments of the invention may be powered utilizing a number of hardware components. Systems may be charged by, but are not limited to batteries and/or charging ports. Power may be distributed through systems utilizing mechanisms including but not limited to power distribution boxes. FIG. 12 discloses a distribution of power into the system in the form of simultaneous 12-volt and 48-volt circuits. Nevertheless, power distribution may utilize power arrangements including but not limited to parallel circuits, series circuits, multiple distributed circuits, and/or singular circuits. Additionally or alternatively, circuits may follow voltages including but not limited to those disclosed in FIG. 12. System driving mechanisms may obtain mobile power through arrangements including but not limited to centralized motors, motors connected to individual wheels, and/or motors connected to any subset of wheels. Additionally or alternatively, while FIG. 12 discloses the use of a four-wheel system, systems configured in accordance with numerous embodiments of the invention may utilize any number and/or arrangement of wheels depending on the needs associated with a given system.

Autonomous vehicles configured in accordance with many embodiments of the invention can incorporate various navigation and motion-directed mechanisms including but not limited to engine control units 1250. Engine control units 1250 may monitor hardware including but not limited to steering, standard brakes, emergency brakes, and speed control mechanisms. Navigation by systems configured in accordance with numerous embodiments of the invention may be governed by navigation devices 1260 including but not limited to inertial measurement units (IMUs), inertial navigation systems (INSs), global navigation satellite systems (GNSS), cameras, time of flight cameras, structured illumination, light detection and ranging systems (LiDARs), laser range finders and/or proximity sensors. IMUs may output specific forces, angular velocities, and/or orientations of the autonomous robots. INSs may output measurements from motion sensors and/or rotation sensors.

Autonomous robots may include one or more peripheral mechanisms (peripherals). Peripherals 1270 may include any of a variety of components for capturing data, including but not limited to cameras, speakers, displays, and/or sensors. In a variety of embodiments, peripherals can be used to gather inputs and/or provide outputs. Autonomous robots can utilize network interfaces to transmit and receive data over networks based on the instructions performed by processors. Peripherals 1270 and/or network interfaces in accordance with many embodiments of the invention can be used to gather inputs that can be used to localize and/or navigate ANSs. Sensors may include but are not limited to ultrasonic sensors, motion sensors, light sensors, infrared sensors, and/or custom sensors. Displays may include but are not limited to illuminators, LED lights, LCD lights, LED displays, and/or LCD displays. Intent communicators may be governed by a number of devices and/or components directed to informing third parties of autonomous navigation system motion, including but not limited to turn signals and/or speakers.

While not necessarily stated explicitly herein, each of the payload management systems, devices, and associated equipment can form a part of autonomous robots in accordance with several embodiments of the invention. Furthermore, the various features of each of the different payload management systems should be understood to be interchangeable and the illustration and/or discussion of particular combinations of features should not be regarded as limiting on the possible configurations of payload management systems implemented in accordance with various embodiments of the invention. Accordingly, it should be appreciated that the payload management systems described herein can also be implemented outside the context of an autonomous robot described above with reference to FIGS. 1-12.

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A delivery mechanism comprising:
a mechanical linkage, the mechanical linkage comprising:
a plurality of rocking bars, wherein each rocking bar of the plurality of rocking bars is mounted to:
a chassis, at a first end of the rocking bar; and
a first cross bar, at a second end of the rocking bar;
a plurality of linear actuators, wherein:
the plurality of linear actuators comprise piston-type actuators configured to move at least one payload in and out of at least one compartment; and
one end of each linear actuator of the plurality of linear actuators is mounted to an individual rocking bar of the plurality of rocking bars; and
at least one grapple, wherein:
each grapple of the at least one grapple:
comprises a hook mounted to a claw; and
is mounted to a second cross bar; and
the hook is configured, in response to a grapple motor, to:
open and close around the at least one payload; and
rotate around the claw; and
a control circuit, wherein the control circuit is configured to:
open, close, and rotate the hook using at least one of the grapple motor or an end-of-travel switch; and
move the plurality of linear actuators relative to the plurality of rocking bars.

2. The delivery mechanism of claim 1, further comprising:
a vehicle frame appended to the chassis;
a plurality of panels attached to the vehicle frame, wherein the plurality of panels construct the at least one compartment; and
a plurality of wheels, wherein the plurality of wheels are:
appended to the chassis; and
powered by a centralized motor to transport the delivery mechanism to a predetermined destination.

3. The delivery mechanism of claim 2, further comprising a plurality of sensors, wherein the plurality of sensors is used to identify at least one of:
a given payload of the at least one payload, to configure the hook to open and close around the given payload; or
the predetermined destination.

4. The delivery mechanism of claim 3, wherein, in response to the identification by the plurality of sensors, the mechanical linkage is configured to perform at least one of:
picking up the given payload from the predetermined destination; or
dropping off the given payload at the predetermined destination.

5. The delivery mechanism of claim 3, wherein the mechanical linkage has a plurality of modes, comprising:
a travel mode, wherein:
the mechanical linkage is in a retracted configuration; and
the delivery mechanism is traveling to the predetermined destination; and
a delivery mode, wherein:
the mechanical linkage is in an extended configuration; and
the delivery mechanism is stationary.

6. The delivery mechanism of claim 5, wherein no weight is applied, from the at least one payload to the mechanical linkage, when the mechanical linkage is in the travel mode and in the delivery mode.

7. The delivery mechanism of claim 3, wherein the plurality of sensors comprises at least one of:
a plurality of cameras, wherein the plurality of cameras are appended on top of the vehicle frame; or
a plurality of ultrasonic sensors, wherein the plurality of ultrasonic sensors are appended to the chassis.

8. The delivery mechanism of claim 7, wherein:
the plurality of cameras overhang at least one contour connecting a first panel appended to the vehicle frame to a second panel appended to the vehicle frame; and
the at least one contour is configured such that each field of view cone produced by the plurality of cameras excludes the delivery mechanism.

9. The delivery mechanism of claim 7, wherein the plurality of cameras comprises:
two front-facing cameras; and
two rear-facing cameras, wherein the two rear-facing cameras are placed opposite the two front-facing cameras on the top of the vehicle frame.

10. The delivery mechanism of claim 9, wherein the plurality of cameras further comprises:
two front-side cameras, wherein the two front-side cameras have a 45-degree yaw inward; and
two rear-side cameras, wherein the two rear-side cameras: have a 45-degree yaw inward; and are placed opposite the two front-side cameras on the top of the vehicle frame.

11. The delivery mechanism of claim 2, wherein the hook connects to the control circuit through at least one of:
a close hook wireless relay in the control circuit; and
an open hook wireless relay in the control circuit.

12. The delivery mechanism of claim 11, wherein:
the close hook wireless relay is coupled to a closed travel limit switch; and
the open hook wireless relay coupled to an open travel limit switch.

13. The delivery mechanism of claim 11, wherein at least one of the close hook wireless relay or the open hook wireless relay is coupled to the centralized motor.

14. The delivery mechanism of claim 2, further comprising a gate, wherein at least two of the plurality of linear actuators are:
arranged in parallel;
attached to either side of the gate; and
configured to convert the gate into a ramp for the at least one payload.

15. The delivery mechanism of claim 14, wherein the gate comprises a conveyor belt.

16. The delivery mechanism of claim 1, wherein the end-of-travel switch determines when the grapple motor activates, deactivates, and changes direction.

17. The delivery mechanism of claim 1, further comprising a hanger, wherein the hanger provides additional support to weights of the at least one payload when one or more payloads of the at least one payload are moved by the mechanical linkage.

18. The delivery mechanism of claim 1, wherein the at least one grapple comprises a motor relay, wherein the motor relay controls the grapple motor.

19. The delivery mechanism of claim 18, wherein the grapple motor is configured to mesh a gear to rotate the hook relative to the claw.

20. The delivery mechanism of claim 1, wherein a first grapple of the at least one grapple is configured to open to release a first payload of the at least one payload, while a second grapple of the at least one grapple remains closed around a second payload of the at least one payload.
